(19) United States
(12) Patent Application Publication
(10) Pub. No.: US 2025/0146137 A1
(43) Pub. Date: May 8, 2025

(54) SELECTIVE SOLUBILIZATION OF GANGUE FROM COPPER CONCENTRATE USING BIOSOLVENTS

(71) Applicant: Allonnia, LLC, Boston, MA (US)

(72) Inventors: Dayal Saran, Boston, MA (US); Coy Zimmermann, Boston, MA (US); Bianca Cruz, Boston, MA (US); Michaeline Albright, Boston, MA (US); Kathleen Radloff, Boston, MA (US); Kent Sorenson, Boston, MA (US); Dan Stigers, Boston, MA (US)

(73) Assignee: Allonnia, LLC, Boston, MA (US)

(21) Appl. No.: 18/936,858

(22) Filed: Nov. 4, 2024

Related U.S. Application Data
(60) Provisional application No. 63/547,324, filed on Nov. 3, 2023.

(51) Int. Cl. C23F 1/18; C01G 3/00

(52) U.S. Cl. CPC C23F 1/18; C01G 3/00

(57) ABSTRACT

A mixture includes a copper concentrate and an extraction composition. The extraction solution includes an aqueous solution that includes a first organic acid, an optional additional organic acid, and optionally an inorganic acid. The extraction composition is configured to selectively solubilize one or more components include a magnesium (Mg) component, an aluminum (Al) component, a silicon (Si) component, a fluorine (F) component, an iron (Fe) component, a molybdenum (Mo) component, or any combination thereof from the copper concentrate. A method for extracting a metal from copper concentrate. The method includes selectively solubilizing a Mg component, Al component, Fe component, Si component, F component, and/or Mo component including one or more minerals, one or more salts, or any combination thereof from copper concentrate into an extraction composition. The extraction composition includes an aqueous solution of an organic acid, an optional additional organic acid, and an optional inorganic acid.

### CROSS-REFERENCE TO RELATED APPLICATION

This application claims benefit to U.S. Provisional Application No. 63/547,324 filed on Nov. 3, 2023, and is related to U.S. Provisional Application Nos. 63/701,293 and 63/701,301 filed on Sep. 30, 2024. The entire contents of each of these applications are incorporated herein by reference in their entirety.

### BACKGROUND

In the mining industry, there has been a general decline in ore grades over time. Decreasing ore quality requires more efficient operation or additional capital expenditure to meet production targets. This also presents an additional issue as further development of electrification technologies, such as battery economy and urbanization fuels, drives demand for relatively higher-grade ores of nickel, lithium, copper, rare earth metals, among others. Accordingly, there exists a need for methods for more sustainable mining practices to ensure production of high-grade ore.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a mixture that includes a copper concentrate and an extraction composition. The extraction solution includes an aqueous solution that includes a first organic acid, an optional additional organic acid, and optionally an inorganic acid. The extraction composition is configured to selectively solubilize one or more components include a magnesium (Mg) component, an aluminum (Al) component, a silicon (Si) component, a fluorine (F) component, an iron (Fe) component, a molybdenum (Mo) component, or any combination thereof from the copper concentrate. The one or more components includeone or more of an atom, a mineral, a salt of Mg, Al, Si, F, Fe, Mo, or any combination thereof.

In another aspect, embodiments herein relate to a method for extracting a metal from copper concentrate. The method includes selectively solubilizing a Mg component, Al component, Fe component, Si component, F component, and/or Mo component comprising one or more minerals, one or more salts, or any combination thereof from copper concentrate into an extraction composition. The extraction composition comprises an aqueous solution of an organic acid, an optional additional organic acid, and an optional inorganic acid.

In another aspect, embodiments herein relate to a method for extracting an impurity from a copper concentrate. The method includes extracting one or more components with an extraction composition. The one or more components include one or more of a Mg component, Al component, Fe component, Si component, F component, and/or Mo component, and one or more minerals, one or more salts, or any combination thereof from the copper concentrate. The extraction composition includes an aqueous solution of an organic acid selected from gluconic acid, oxalic acid, and mixtures thereof, separating the copper concentrate from the one or more components and the extraction composition, separating the extraction composition from the one or more components, and repeating the extracting. The separated one or more components have a purity in a range from 10% to 90%.

Other aspects and advantages of the claimed subject matter will be apparent from the following description and the appended claims.

### BRIEF DESCRIPTION OF DRAWINGS

FIG. 1 is a method of extracting a metal from a copper-containing ore material in accordance with one or more embodiments.

FIG. 2 is a simplified block flow diagram of an extraction process that recycles an extraction composition in accordance with one or more embodiments.

FIG. 3A is a graph showing amounts of aluminum (Al), copper (Cu), iron (Fe), magnesium (Mg), molybdenum (Mo), and silicon-containing compounds (Si) dissolved as a function of different aqueous solutions in 2 hours.

FIG. 3B is a graph showing amounts of Al, Cu, Fe, Mg, Mo, and Si dissolved as a function of different aqueous solutions in 6 hours.

FIG. 3C is a graph showing amounts of Al, Cu, Fe, Mg, Mo, and Si dissolved as a function of different aqueous solutions in 24 hours.

FIG. 4 is a graph showing percentage of Al, Cu, Fe, Mg, Mo, and Si dissolved as a function of aqueous solutions after 24 hours.

FIG. 5 is a graph showing the absorption of cations to an ion exchange resin over time.

FIG. 6 is a graph showing the percentage of dissolved elements in an extracted solution formed from a fresh (i.e., “original”) extraction composition and copper concentrate as compared to an extracted solution formed from a regenerated extraction composition and a copper concentrate.

### DETAILED DESCRIPTION

In the following detailed description of embodiments of the disclosure, numerous specific details are set forth in order to provide a more thorough understanding of the disclosure. However, it will be apparent to one of ordinary skill in the art that the disclosure may be practiced without these specific details. In other instances, well-known features have not been described in detail to avoid unnecessarily complicating the description.

One or more embodiments of the present disclosure are directed to compositions, systems, and methods for enrichment of ore materials, such as a copper-containing ore concentrate (or “copper concentrate”) thereof. For example, in one or more embodiments, methods for (a) selectively removing one or more components (e.g., gangue and impurities) to improve ore grade, (b) selectively removing gangue or impurities from ore to improve processing, (c) extracting metals of value from gangue are described. As one of ordinary skill may appreciate, the term “gangue” as used herein refers to the material proximate to or in which ore is found having relatively little value as compared to the ore. A method in accordance with the present disclosure may include solubilizing of select metals and/or impurities (e.g., non-metal components) from a copper concentrate, which can include copper-containing ore materials, such as ore tailings and/or from ore substrates and/or gangue material. In some embodiments, the selective solubilization of metals and/or cations from copper-containing ore materials may support carbon sequestration.

Organic acids, such as citric acid and mixtures of organic acids including gluconic and oxalic acid, have been used to solubilize certain atoms from ore materials. Previously, gluconic and oxalic acid were often found to solubilize iron atoms and/or non-targeted atoms, which decreases the value of the ore material in further downstream processes. However, advantageously, one or more embodiments of the present disclosure unexpectedly show selective removal of aluminum (Al), silicon (Si), magnesium (Mg), molybdenum (Mo), fluorine (F), and iron (Fe) relative to other components including, but not limited to, copper (Cu) from copper-containing ore materials (e.g., a copper concentrate), which significantly improves the value of the copper material in further downstream processes. such as a smelting process.

The composition, system, and/or method of one or more embodiments may be directed to the enrichment or upgrading of copper ore materials by selectively removing one or more components, including, but not limited to, Al, Mg, F, Mo, and Si from a copper concentrate. One or more embodiments herein may relate to a method for advantageously improving a grade of a copper ore material by selectively reducing Al, Mg, F, Mo, and Si from the copper ore material (e.g., a copper concentrate). This selectivity may be achieved via solubilization of a component that can include one or more of Al, Mg, F, Mo, Si while keeping most of the metals of value (e.g., copper) in the solid ore material. In addition, Fe components (e.g., iron atoms) may be solubilized to a lesser extent than the Mg and/or Al components, which is an unexpected shift in selectivity as compared to traditional processes.

As used herein, the term “organic acid” may include an individual organic acid and/or mixtures of organic acids that are produced by microbes (e.g., in a biobroth), or organic acids from other biological sources (e.g., in a plant produced biobroth), or organic acids that are synthetically made. The “organic acid” as used throughout this disclosure can include a mixture of an organic acid and the respective conjugate base.

As used herein, the terms “biosolvent” and “biobroth” refer to a solution including inorganic and/or organic acids and their respective conjugate bases, one or more biobroths, ionic liquids, or any combination thereof. The biosolvent of one or more embodiments may be either derived biologically or synthetically and may or may not include silicase and/or other enzymes. The term “biobroth” may refer to a solution produced and obtained from a natural and/or engineered organic acid-producing microbe, such as via a fermentation process, a natural and/or engineered organic acid-producing plant, or combinations thereof. The organic acid-producing microbe may produce an organic acid or a mixture of organic acids. The organic acid-producing microbe may produce one or more organic acids and one or more components, such as primary metabolites, secondary metabolites, antibodies, salts, ions, organelles, cellular components, extracellular components, biomolecules (e.g., polysaccharides, proteins, enzymes, amino acids, nucleic acids, lipids, carbohydrates, among others), or any combination thereof. The term “engineered microbe” may be a microbe that has been altered, such as with genetic engineering, for example, to modulate acid or other biobroth component production.

The terms “biosolvent” and “biobroth” may refer to a complex mixture of components derived from an organism, such as a broth obtained from a culture of a microbe, such as a fungus. The complex mixture can include inorganic and/or organic acids and their respective conjugate bases, ionic liquids, amino acids, cellular components derived from a microbe, extracellular components derived from a microbe, or any combination thereof. For example, the biobroth can include one or more enzymes, such as silicase. The biobroth of one or more embodiments may be obtained from an Aspergillus spp. culture, such as a supernatant, a cell lysate, or combinations thereof. The natural and/or engineered microbe may include, but is not limited to, a microorganism of a genus selected from the group consisting of Aspergillus, Acetobacter, Bacillus, Propionibacterium, Corynebacterium, Rhizopus, Clostridium, Fusobacterium, Pseudomonas, Bifidobacterium, Saccharomyces, Enterobacter, Escherichia (e.g., Escherichia coli), and combinations thereof.

As used herein, the term “inorganic acid” may be an acid that is derived from an inorganic compound. The inorganic acid of one or more embodiments may include a protic acid.

As used herein, the term “gangue” refers to the impurity material that surrounds or is closely mixed with a wanted mineral in an ore deposit. Although termed “impurities” it is understood that value can be obtained from certain elements in the gangue, and that such elements are impurities with respect to the wanted material in the ore deposit.

As used herein, the phrase “total mass loss” refers to the difference between a mass of a material after a certain treatment from a mass of a material before a certain treatment. For example, “total mass loss” may refer to a change in mass in an ore material before and after exposure to an extraction process in accordance with one or more embodiments.

As used herein, the phrase “total volume loss” refers to the difference between a volume of a material after a certain treatment from a volume of a material before a certain treatment. For example, “total volume loss” may refer to a change in volume in an extraction composition (e.g., before an extraction process as compared to an extracted solution that has been separated from solid material obtained after an extraction process) in accordance with one or more embodiments.

As used herein, the terms “load” or “leach” refers to the process of transferring one or more components from a first material to a second material. For example, the process of “loading” or “leaching” may include transferring one or more components from an ore material to an extraction composition in accordance with one or more embodiments.

As used herein, the terms “strip” or “separate” refers to the removal of a first component (e.g., an impurity component, a biobroth, a biosolvent, an organic acid, etc.) from a second component (e.g., a mixture, solution, ore material, etc.).

As used herein, the terms “recycle” or “regenerate” refers to the recovery of a material (e.g., a component of an extraction composition, an extraction composition, or both such that the material may be reused in subsequent processes.

As disclosed herein, one or more embodiments may relate to combinations of inorganic acids and organic acids and conjugate bases, and optionally one or more additives, at adjusted pH to selectively (a) remove impurities from ore to improve ore grade, (b) remove impurities from ore to improve processing, and (c) extract metals of value from gangue. These combinations selectively solubilize impurities to a greater extent than previous work and open the possibility of using these technological improvements in mining industry processes.

### Extraction Composition and Mixture

In one aspect, embodiments herein relate to an extraction composition. In another aspect, embodiments herein relate to an extraction mixture including an extraction composition and an ore material. As used herein, the term “ore material” refers to a copper concentrate, which can include one or more of a copper-containing ore, copper concentrate after flotation, copper ore tailings, waste rock including copper, among other copper ore materials. The copper concentrate may include, but is not limited to, a copper-containing compound including or be derived from the group consisting of copper sulfides, copper carbonates, copper hydroxides, copper oxides, among others, and combinations thereof. The copper concentrate of one or more embodiments may include copper-containing ore tailings, a concentrate derived from copper-containing ore tailings, a copper concentrate obtained prior to a flotation process, a copper concentrate following a flotation process, or any combination thereof. A concentrate of the copper-containing ore may include copper-containing ore tailings.

The extraction composition may include one or more selected from a biosolvent, a biobroth, or any combination thereof. The extraction composition may include a biosolvent that has been synthetically produced, such as a biosolvent prepared in a laboratory environment. The extraction composition may include a biobroth obtained from a natural and/or engineered microbe or another biological source (e.g., plant derived). The extraction composition may be a biosolvent or a biobroth. The extraction composition may be configured to selectively extract one or more components from a copper concentrate. In one or more embodiments, the extraction composition is configured to extract a Mg component, an Al component, an Fe component, a Si component, a Mo component, a F component, or any combination thereof. In some embodiments, the extraction composition is configured to selectively extract a magnesium component with an iron component being solubilized to a lesser extent.

The extraction composition may include an aqueous solution. The aqueous solution includes water. The water may include, but is not limited to, Milli-Q water, distilled water, deionized water, tap water, fresh water from surface or subsurface sources, formation water, natural and synthetic brines, brackish water, natural and synthetic sea water, potable water, non-potable water, process water, other waters, and combinations thereof, that are suitable for use for treating a copper-containing ore and/or a concentrate thereof. As used herein, “Milli-Q water” is water purified using a Millipore Milli-Q laboratory water system. In one or more embodiments, the basic Milli-Q water meets ASTM Type I standards, having greater than 18.0 MegaOhms·centimeter (M (2·cm) resistivity at 25EC due to ions, less than 10 parts per billion (ppb) organics, less than 0.03 endotoxin per milliliter (EU/mL) of pyrogens, less than 1 particulate per mL (pariculate/mL), less than 10 ppb silica, and less than 1 bacterial colony forming unit per mL (cfu/mL).

In one or more embodiments, the water used may naturally contain contaminants, such as salts, ions, minerals, organics, and combinations thereof, as long as the contaminants do not interfere with extraction of target metal atoms and/or impurities from an ore material. In one or more embodiments, one or more additives may be added to the extraction composition to enhance the selectivity for one or more components, efficiency for removing the one or more components, or combinations thereof.

In one or more embodiments, the aqueous solution includes a first organic acid, an optional additional organic acid, and an optional inorganic acid. The extraction composition may include a plurality of organic acids. For example, the extraction composition may include two or more, three or more organic acids, four or more organic acids, five or more organic acids, six or more organic acids, eight or more organic acids, or ten or more organic acids, etc. The first organic acid may include one or more organic acids, two or more organic acids, or a plurality of organic acids. In some embodiments, when the first organic acid includes two or more organic acids, a main organic acid component may be present as compared to a minor organic acid component.

The first organic acid may be an acid selected from the group consisting of gluconic acid, oxalic acid, and combinations thereof. As a non-limiting example, the first organic acid may include oxalic acid and gluconic acid as a minor component. In one or more embodiments, the first organic acid includes gluconic acid as a main component and oxalic acid as a minor component. The first organic acid may be gluconic acid or oxalic acid. In some embodiments, the first organic acid, the optional additional organic acid, or both are synthetically produced, such as in a laboratory. In some embodiments, the first organic acid, the optional additional organic acid, or both are naturally occurring such that at least a portion of the aqueous solution may be or may be isolated from a “biobroth.” In one or more embodiments, the biosolvent includes purified (e.g. purified individual organic acids and/or purified mixtures of organic acids) or mixtures of unpurified organic acids. The biosolvent of one or more embodiments may be used with single or mixtures of inorganic acids.

In one or more embodiments, the first organic acid is present in the aqueous solution in a concentration in a range between 0.01 M (Molar) to 4 M. For example, the concentration of the first organic acid may be in a range having a lower limit of any one of a non-zero value, 0.010 M, 0.015 M, 0.020 M, 0.025 M, 0.05 M, 0.075 M, 0.09 M, 0.10 M, 0.125 M, 0.150 M, 0.250 M, 0.5 M, 0.6 M, 0.8 M, 0.9 M, 1 M, 1.5 M, 2M, 2.5 M, 3M, 3.5 M, and 3.9 M and an upper limit of any one of 0.05 M, 0.075 M, 0.09 M, 0.10 M, 0.125 M, 0.150 M, 0.250 M, 0.5 M, 0.6 M, 0.7 M, 0.8 M, 0.9 M, 1.0 M, 1.1 M, 1.2 M, 1.5 M, 2 M, 2.5 M, 3 M, 3.5 M, 3.9 M, 3.95 M, and 4 M, where any lower limit can be paired with any mathematically compatible upper limit. As a non-limiting example, the concentration of the first organic acid may be present in a biosolvent at a concentration in a range from a non-zero value to 1.5 M, such as 0.05 M to 1.0 M.

The additional organic acid may include one or more organic acids, two or more organic acids, or a plurality of organic acids. In some embodiments, when the additional organic acid includes two or more organic acids, a main organic acid component may be present as compared to a minor organic acid component. The additional organic acid may include an acid selected from the group consisting of citric acid, malic acid, formic acid, lactic acid, acetic acid, hydroxypropionic acid, phthalic acid, tartaric acid, hexadecenoic acid, heptadecanoic acid, gallic acid, aspartic acid, succinic acid, oleic acid, tannic acid, palmitic acid, and combinations thereof.

In one or more embodiments, when the first organic acid is, or includes as a main component, oxalic acid, the additional organic acid comprises an acid selected from the group consisting of gluconic acid, oxalic acid, lactic acid, acetic acid, malic acid, hydroxypropionic acid, phthalic acid, tartaric acid, hexadecenoic acid, heptadecanoic acid, gallic acid, aspartic acid, succinic acid, oleic acid, tannic acid, palmitic acid, and combinations thereof. In one or more embodiments, when the first organic acid is, or includes as the main component, gluconic acid, the additional organic acid comprises an acid selected from the group consisting of oxalic acid, lactic acid, acetic acid, citric acid, hydroxypropionic acid, phthalic acid, tartaric acid, hexadecenoic acid, heptadecanoic acid, gallic acid, aspartic acid, succinic acid, oleic acid, tannic acid, palmitic acid, and combinations thereof.

In one or more embodiments, the additional organic acid is present in the aqueous solution in a concentration in a range between 0 M to 1.5 M. For example, the concentration of the first organic acid may be in a range having a lower limit of any one of 0 M, a non-zero value, 0.005 M, 0.010 M, 0.015 M, 0.020 M, 0.025 M, 0.05 M, 0.075 M, 0.09 M, 0.10 M, 0.125 M, 0.150 M, 0.250 M, 0.5 M, 0.6 M, 0.8 M, and 0.9 M and an upper limit of any one of 0.05 M, 0.075 M, 0.09 M, 0.10 M, 0.125 M, 0.150 M, 0.250 M, 0.5 M, 0.6 M, 0.7 M, 0.8 M, 0.9 M, 1.0 M, 1.1 M, and 1.5 M, where any lower limit can be paired with any mathematically compatible upper limit.

In some embodiments, a ratio of the first organic acid to the additional organic acid is a concentration ratio in a range from 1:0 to 1: less than or equal to (≤) 1. In one or more embodiments, the concentration ratio of the first organic acid to the additional organic acid is in a range having a lower limit of any one of 1:0, 1:0.05, 1:0.1, 1:0.2, 1:0.3, 1:0.4, 1:0.5, and 1:0.75, and an upper limit of any one of 1:0.1, 1:0.2, 1:0.3, 1:0.4, 1:0.5, 1:0.6, 1:0.7, 1:0.75, 1:0.8, 1:0.85, 1:0.9, 1:0.95, 1:0.99, and 1:1, where any lower limit can be paired with any mathematically compatible upper limit.

In one or more embodiments, the extraction composition includes an inorganic acid. The inorganic acid may include an acid selected from the group consisting of sulfuric acid, hydrochloric acid, nitric acid, phosphoric acid, and combinations thereof. The inorganic acid may be included in the aqueous fluid in an amount in a range from 0 M or a non-zero concentration to 1.5 M. For example, the concentration of the inorganic acid may be in a range having a lower limit of any one of 0 M, 0.005 M, 0.010 M, 0.015 M, 0.020 M, 0.025 M, 0.05 M, 0.075 M, 0.09 M, 0.10 M, 0.125 M, 0.150 M, 0.250 M, 0.5 M, 0.6 M, 0.8 M, and 0.9 M and an upper limit of any one of 0.05 M, 0.075 M, 0.09 M, 0.10 M, 0.125 M, 0.150 M, 0.250 M, 0.5 M, 0.6 M, 0.7 M, 0.8 M, 0.9 M, 1.0 M, 1.1 M, and 1.5 M, where any lower limit can be paired with any mathematically compatible upper limit.

The extraction composition of one or more embodiments has a pH in a range from 0.09 to 4.2. In some embodiments, the pH of the extraction composition is in a range having a lower limit of any one of 0.09, 0.10, 0.2, 0.25, 0.5, 0.75, 1, 1.2, 1.5, 1.7, 1.9, 2.0, 2.2, 2.5, 2.7, 2.9, 3.0, 3.2, 3.5, and 3.7 and an upper limit of any one of 1, 1.2, 1.5, 1.7, 1.9, 2.0, 2.2, 2.5, 2.7, 2.9, 3.0, 3.2, 3.5, 3.7, 3.9, 4.0, and 4.2, where any lower limit can be paired with any mathematically compatible upper limit.

Method for Extracting One or More Components from a Copper-Containing Ore Material

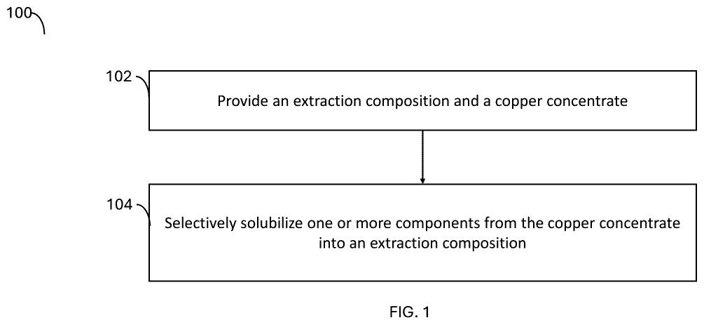

In another aspect, embodiments herein relate to a method for extracting a metal from an ore material, such as a copper concentrate. A non-limiting method may be as shown in FIG. 1 (e.g., method 100). In some embodiments, method 100 may include block 102 such that an extraction composition and an ore material is provided as shown in FIG. 1. As shown in block 104, method 100 may include selectively solubilizing an impurity component including one or more minerals, salt, or any combination thereof having Mg, Al, F, Si, and Mo from a copper concentrate into an extraction composition.

The method may include preparing the extraction composition by obtaining the first organic acid and, optionally, the additional organic acid, the inorganic acid, or combinations thereof. One or more organic acids of the extraction composition may be obtained via synthetic laboratory procedures. The first organic acid, the additional organic acid, the inorganic acid, or combinations thereof may be microbially produced, plant produced, or both such that the first organic acid, the additional organic acid, the inorganic acid, or combinations thereof may be collected from a microbe, a plant, or both. In some embodiments, the first organic acid, the additional organic acid, the inorganic acid, or combinations thereof is collected from a plant extract, a microbial cell lysate, a microbial supernatant, or combinations thereof. One or more organic acids of the extraction composition may be purified.

The method may include forming the mixture including an extraction composition and an ore material. The extraction composition and the ore material may be as previously described. An extraction composition, an ore material, or both may be introduced (or added) to an extraction unit of an extraction zone, such as an agitated leaching tank of an extraction system. In some embodiments, the extraction zone is a laboratory extraction unit that is a container capable of being manually agitated or stirred for the extraction process. The extraction unit may be a container capable of being automatically agitated or stirred for the extraction process, such as with a control system in electrical connection with the extraction unit. In some embodiments, the method includes providing an extraction system capable of performing one or more leaching processes. The extraction system may include one or more flow lines, valves, pumps, storage tanks, an extraction zone including an extraction unit (e.g., one or more agitated leaching tanks), among one or more additional units known to those skilled in the art for mineral leaching. One or more components of the extraction system may be an add-on component capable of being incorporated to one or more industrial mining processes.

In some embodiments, the extraction zone includes a plurality of leaching tanks positioned in parallel or in series. In one or more embodiments, one or more leaching tanks of the plurality of leaching tanks are in fluid communication with a subsequent leaching tank of the plurality of leaching tanks. In some embodiments, plurality of leaching tanks are positioned in a cross- or counter-current design, in locked cycle leaching, or combinations thereof.

The ore material may be added to the extraction zone in an amount in a range from 5 to 55 wt % based on the total weight of the extraction mixture. The ore material may be added to the extraction unit in an amount in a range having a lower limit of any one of 5 wt %, 7.5 wt %, 8 wt %, 10 wt %, 15 wt %, 20 wt %, 25 wt %, 30 wt %, 40 wt %, 45 wt %, 48 wt %, and 50 wt % and an upper limit of any one of 15 wt %, 20 wt %, 25 wt %, 30 wt %, 40 wt %, 45 wt %, 48 wt %, 50 wt %, 51 wt %, 52 wt %, 53 wt %, 54 wt %, and 55 wt %, where any lower limit can be paired with any mathematically compatible upper limit.

The extraction composition may be added to the extraction unit in an amount in a range from 45 to 95 wt % based on the total weight of the extraction mixture. The extraction composition may be added to the extraction unit in an amount in a range having a lower limit of any one of 45 wt %, 47.5 wt %, 48 wt %, 50 wt %, 55 wt %, 60 wt %, 65 wt %, 70 wt %, 70 wt %, 75 wt %, 78 wt %, and 80 wt % and an upper limit of any one of 55 wt %, 60 wt %, 65 wt %, 70 wt %, 75 wt %, 80 wt %, 85 wt %, 88 wt %, 90 wt %, 91 wt %, 92 wt %, 93 wt %, 94 wt %, and 95 wt %, where any lower limit can be paired with any mathematically compatible upper limit.

The mixture of the extraction composition and the ore material may be agitated in the extraction zone. The mixture may be heated while agitating to promote the selective removal of one or more components from the ore material. Agitating the extraction mixture in the extraction zone may form an extracted solution (or a “liquid mixture”) including the organic acid, the magnesium component, and, optionally, one or more additional components extracted from the copper-containing ore and/or concentrate thereof. The extraction mixture may be agitated in the extraction unit for a period of time in a range having a lower limit of any one of 0.25 hour (h), 0.5 h, 1 h, 2 h, 3, h, 4 h, 5 h, 6 h, 8 h, 10 h, 12 h, 14 h, 16 h, 18 h, and 20 h, and an upper limit of any one of 4 h, 5 h, 6 h, 7 h, 8 h, 10 h, 12 h, 14 h, 16 h, 18 h, 20 h, 22 h, 24 h, and 26 h, where any lower limit can be paired with mathematically compatible upper limit. The mixture may be heated (e.g., in the extraction unit) at a temperature in a range from 20° C., 25° C., 27° C., 28° C., 29° C., 30° C., 35° C., 40° C., 45° C., 50° C., 60° C., 70° C., 80° C., 90° C., 95° C., and 99° C. and an upper limit of any one of 35° C., 40° C., 45° C., 50° C., 55° C., 60° C., 65° C., 70° C., 75° C., 80° C., 90° C., 95° C., 99° C., and 100° C., where any lower limit can be paired with any mathematically compatible upper limit. In a non-limiting example, the method may include adjusting a temperature of the extraction zone to a temperature in a range from 20 to 100° C. and performing the extraction zone for a period of time in a range from 1 to 24 hours.

During the agitating step, one or more components may be selectively transferred from the ore material to the extraction composition, thereby forming an extraction mixture including a treated ore material and an extracted solution. The extracted solution of one or more embodiments includes the extraction composition and one or more components removed from the ore material that may include one or more selected from a Mg component, an Fe component, a Si component, an Al component, a Mo component, a F component, among other components (e.g., a lesser amount of a copper component). In some embodiments, the one or more components can include an iron component, and/or a copper component as relatively minor components compared to the Mg, Al, Mo, Si, and/or F components. In such embodiments, the method of extraction is selective for the Mg, Al, Mo, Si, and F components removal from the ore material. While a quantity of iron may also be solubilized by the extraction composition, advantageously, the extraction composition selectively solubilizes other elements such that iron is solubilized to a lesser extent. Reducing iron loss may advantageously improve heat transfer in subsequent smelting and improve copper recovery.

The one or more components may include an impurity in the form of a mineral, an oxide, a salt, or any combination thereof. The Mg component may include one or more of a Mg mineral, elemental Mg, a Mg oxide, a Mg salt having a Mg cation, or any other form of Mg. The Al component may include one or more of an Al mineral, elemental Al, an Al oxide, an Al salt having an Al cation, or any other form of Al. The Mo component may include one or more of a Mo mineral, elemental Mo, a Mo oxide, a Mo salt having a Mo cation, or any other form of Mo. The Si component may include one or more of a Si mineral, elemental Si, a Si oxide, a Si salt, or any other form of Si. The Fe component may include one or more of a Fe mineral, elemental Fe, a Fe oxide, a Fe salt having a Fe cation, or any other form of Fe. The F component may include one or more of a fluoride ion, diatomic fluorine, or any other form of F. A copper (Cu) component may include a Cu mineral, elemental Cu, a Cu oxide, a Cu salt having a Cu cation, or any other form of Cu.

The treated ore material may have a reduced concentration of one or more impurity components (e.g., one or more components described previously herein) as compared to the untreated ore material, such as a percent of the one or more impurity component concentration(s) in the untreated ore material. The method of one or more embodiments may reduce the one or more impurity components in a treated ore material as compared to an untreated ore material by a relative percent. The relative percent of an impurity component reduced in a treated ore material as compared to an untreated ore material may be in a range having a lower limit of any one of a non-zero value, 1%, 2%, 5%, 10%, 15%, 20%, 25%, 30%, 35%, 40%, 45%, 50%, 55%, 60%, 65%, 70%, 75%, 80%, 85%, and 90%, and an upper limit of any one of 10%, 20%, 25%, 30%, 35%, 40%, 45%, 50%, 55%, 60%, 65%, 70%, 75%, 80%, 85%, 90%, 95%, 98%, 99%, 99.5%, 99.8%, 99.9%, and 100% where any lower limit can be paired with any mathematically compatible upper limit.

The method of one or more embodiments may reduce the one or more impurity components in an ore material to provide a total mass loss of the impurity component of about 1 wt % to about 100 wt %. The reduced one or more components content in an ore material may be reduced by an amount in a range having a lower limit of any one of 1 wt %, 2.5 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, and 75 wt % and an upper limit of any one of 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 95 wt %, and 100 wt %, where any lower limit can be paired with any mathematically compatible upper limit.

In one or more embodiments, the untreated ore material has one or more impurity component content in a range from a 0.01 wt % to 85 wt %. The treated ore material may have a concentration of one or more impurity components in a range having a lower limit of any one of 0.01 wt %, 0.05 wt %, 0.1 wt %, 0.25 wt %, 0.5 wt %, 1.0 wt %, 1.5 wt %, 2.0 wt %, 5 wt %, 10 wt %, 15 wt %, 20 wt %, 25 wt %, 30 wt %, 35 wt %, 40 wt %, 45 wt %, 50 wt %, 55 wt %, and 60 wt % and an upper limit of any one of 2.0 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, and 85 wt %, where any lower limit can be paired with any mathematically compatible upper limit.

In some embodiments, the treated ore material has a reduced one or more impurity component content as compared to the untreated ore material. In one or more embodiments, the treated ore material has a reduced impurity component content in a range from a 0 wt % to 85 wt %. The treated ore material may have a concentration of one or more impurities in a range having a lower limit of any one of 0 wt %, a non-zero value, 0.01 wt %, 0.05 wt %, 0.1 wt %, 0.25 wt %, 0.5 wt %, 1.0 wt %, 1.5 wt %, 2.0 wt %, 5 wt %, 10 wt %, 15 wt %, 20 wt %, 25 wt %, 30 wt %, 35 wt %, 40 wt %, 45 wt %, 50 wt %, 55 wt %, and 60 wt % and an upper limit of any one of 2.0 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, and 85 wt %, where any lower limit can be paired with any mathematically compatible upper limit. As a non-limiting example, the reduced one or more impurity component concentration in the treated ore material may be in a range from 0 to 85 wt %. In one or more embodiments, the amount of impurity components in a treated ore material is less than 85 wt %, less than 80 wt %, less than 75 wt %, less than 50 wt %, less than 25 wt %, or less than 10 wt %. In some embodiments, the ore material is upgraded by the selective removal of one or more of Mg, Al, F, Si, Mo, while retaining metals of value (e.g., iron and copper) in the solid ore material.

In embodiments where an impurity is found in an ore material in a relatively low amount (e.g., about 0.001 wt % to about 5 wt %), such impurities may be referred to as penalty elements (or “penalty components”), which are considered non-applicable for further processing. These penalty elements may render an ore material unsuitable for further use. Some non-limiting examples of penalty elements include Mg, Mo, F, P, S, Si, As, Fe, among others. In embodiments in which penalty elements are present in a relatively low amounts in the ore material, the method may advantageously remove one or more impurity components in a relative percentage of 20% or more, 30% more more, 40% or more, 50% or more, 60% or more, 70% or more from the ore material. In embodiments where the ore material is or includes gangue, the method may advantageously increase the value of the ore material via removal of the penalty element while maintaining a relatively large percentage of gangue (e.g., 95%).

In one or more embodiments, the untreated ore material has one or more impurity component content in a range from a 0.001 wt % to 99.999 wt %. The treated ore material may have a concentration of one or more impurity components in a range having a lower limit of any one of 0.001 wt %, 0.01 wt %, 0.05 wt %, 0.1 wt %, 0.25 wt %, 0.5 wt %, 1.0 wt %, 1.5 wt %, 2.0 wt %, 5 wt %, 10 wt %, 15 wt %, 20 wt %, 25 wt %, 30 wt %, 35 wt %, 40 wt %, 45 wt %, 50 wt %, 55 wt %, and 60 wt % and an upper limit of any one of 2.0 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 92.5 wt %, 95 wt %, 97.5 wt %, 99 wt %, 99.5 wt %, 99.9 wt %, 99.99 wt %, and 99.999 wt %, where any lower limit can be paired with any mathematically compatible upper limit.

In some embodiments, the treated ore material has a reduced one or more impurity component content as compared to the untreated ore material. In one or more embodiments, the treated ore material has a reduced impurity component content in a range from a 0 wt % to 99.99 wt %. The treated ore material may have a concentration of one or more impurities in a range having a lower limit of any one of 0 wt %, 0.01 wt %, 0.05 wt %, 0.1 wt %, 0.25 wt %, 0.5 wt %, 1.0 wt %, 1.5 wt %, 2.0 wt %, 5 wt %, 10 wt %, 15 wt %, 20 wt %, 25 wt %, 30 wt %, 35 wt %, 40 wt %, 45 wt %, 50 wt %, 55 wt %, and 60 wt % and an upper limit of any one of 2.0 wt %, 5 wt %, 10 wt %, 15 wt %, 20 wt %, 25 wt %, 30 wt %, 35 wt %, 40 wt %, 45 wt %, 50 wt %, 55 wt %, 60 wt %, 65 wt %, 70 wt %, 75 wt %, 80 wt %, 85 wt %, 90 wt %, 92.5 wt %, 95 wt %, 96 wt %, 97 wt %, 98 wt %, 99 wt %, 99.95 wt %, and 99.99 wt %, where any lower limit can be paired with any mathematically compatible upper limit. As a non-limiting example, the reduced one or more impurity component concentration in the treated ore material may be in a range from 0 to 95 wt %. In one or more embodiments, the amount of impurity components in a treated ore material is less than 98 wt %, less than 95 wt %, less than 90 wt %, 85 wt %, less than 80 wt %, less than 75 wt %, less than 50 wt %, less than 25 wt %, or less than 10 wt %. In some embodiments, the ore material is upgraded by the selective removal of one or more of Mg, Al, F, S, P, Si, Mo, while retaining metals of value (e.g., Fe, and/or Cu) in the solid ore material.

A method of one or more embodiments may include separating a treated ore material from the extraction mixture to collect the treated ore and the extracted solution. The treated ore material may be in the form of a solid such that the separation of the treated ore material from the extracted solution can be performed by a method for separating solids from liquids known to those skilled in the art. In some embodiments, the separation includes decanting, filtration, filtration, membrane filtration, gravity filtration, centrifugation, among others known to those skilled in the art. The separated treated ore material may be washed and dried. In some embodiments, the separated treated ore is transferred for further processing.

The separation of the one or more components described previously, and if present, one or more additional metallic components (e.g., a Cu component) from the extracted solution may be performed such that the extraction composition is regenerated. The extracted solution may be fed to a processing unit to regenerate the extraction composition. In some embodiments, separating the one or more components from the extracted solution includes extracting the one or more components from the extracted solution with one or more water treatment techniques. The extraction of the one or more components from the extracted solution may include performing one or more water treatment techniques selected from the group consisting of feeding the extracted solution through an ion exchange system, extracting the impurity component via solvent extraction, chromatography, filtration, nanofiltration, membrane filtration, osmotic separation (e.g., via reverse osmosis), using adsorption and/or absorption materials, pH control and precipitation, and combinations thereof. The water treatment technique may include introducing the extracted solution to an ion exchange column, solvent extraction (e.g., biphasic solvent extraction), or both.

The biosolvent, the biobroth, one or more components of the biosolvent and/or the biobroth (e.g., an organic acid), one or more metals of value, or combinations thereofmay be separated from the extracted solution via feeding the extracted solution to a system configured to perform chromatography, filtration, nanofiltration, membrane filtration, osmotic separation (e.g. via reverse osmosis), using adsorption and/or absorption materials, pH control and precipitation, solvent extraction, ion exchange chromatograph and combinations thereof.

In one or more embodiments, one or more metals of value (e.g., Fe and/or Cu) are removed from the extracted solution via the one or more water treatment techniques. In one or more embodiments, a Cu component is selectively removed from the extracted solution, the extraction mixture, or both. As a non-limiting example, the copper component may be removed (e.g., via electrowinning or other extraction methods) and recovered for further processing of an enriched solid copper concentrate. In a non-limiting example, the extracted copper component may be added to the enriched copper material recovered from the extraction mixture. Advantageously, one or more embodiment methods may allow for a reduced or minimal loss of copper from a copper ore material even if relatively low amounts of leach into the extracted solution.

In some embodiments, separating the extraction composition or one or more components of the extraction composition includes extracting the extraction composition or one or more components of the extraction composition from the extraction mixture, the extracted solution, or both. The extraction may be performed with one or more water treatments techniques selected from a group consisting of centrifugation, feeding the extracted solution through an ion exchange system, extracting the magnesium component via solvent extraction, chromatography, nanofiltration, filtration, membrane filtration, using adsorption and/or absorption materials, pH control and precipitation, and combinations thereof.

An organic acid component of the extraction composition, a biosolvent component of the extraction composition, a biobroth component of the extraction composition, or combinations thereof may be separated from the extracted solution and/or the extraction mixture and may subsequently be used to form a regenerated extraction composition. For example, at least a portion of an extraction composition may be separated from the extraction mixture, the extracted solution, or combinations thereof by pH control and precipitation, chromatography, ion exchange, or filtration. After this, the extracted portion may be recovered as a solid precipitate, in an aqueous solution, or both.

The regenerated extraction composition may be recovered and reused for subsequent extractions. For example, when the extracted portion is recovered as a solid precipitate, the precipitate may be redissolved to form the regenerated extraction composition. In some embodiments, the method includes repeating the extracting, such as with the regenerated extraction composition. In some embodiments, the regenerated extraction composition can be modified after recovery and prior to the repeating the extraction to add an organic acid, an inorganic acid or both, dilute the extraction composition, adjust a pH of the extraction composition (e.g., with a pH adjusting agent that does not interfere with the extraction process), or any combination thereof. The regenerated extraction composition may be transported (i.e., introduced) to the extraction zone, such that the regenerated extraction composition is recycled.

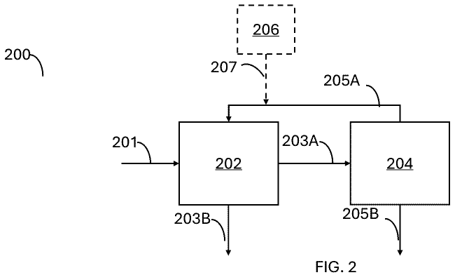

A simplified diagram of a non-limiting extraction process and recycling process may be as shown in FIG. 2. As shown in system 200 of FIG. 2 a copper-containing ore material, an extraction composition, or both may be introduced to extraction zone 202 via feed line 201. An extracted solution may be introduced to component recovery zone 204 via input line 203A. A treated metal ore material may be recovered from extraction zone 202 via output line 203B. The treated ore material may be analyzed, such as weighed to determine a total mass difference from the untreated ore material. The component recovery zone 204 may include a component to selectively remove Mg, Mo, Al, F, Si, Fe, and Cu, among other metal atoms (e.g., via line 205B) from the extracted solution such that the extraction composition is regenerated. In one or more embodiments, F may be removed from a Si-containing mineral or ore material.

One or more impurity components may be separated (or “stripped”) from the extracted solution along with one or more additional metal components (e.g., an iron component, a nickel component, a cobalt component, among others) such that the extraction composition and a mixture of metallic components may be recovered. The magnesium component may be a main component of the mixture of metallic components. In one or more embodiments, each of the Mg, Mo, Fe, Al, Si, and/or F components and, if present, one or more additional metallic components (e.g., Cu) are recovered separately from the extracted solution as recovered components. In some embodiments, the recovered component has a purity in a range from 5% or greater, 10% or greater, 25% or greater, or 50% or greater. The recovered component may have a purity in a range from 5% to 100%. For example, the recovered component may have a purity in a range having a lower limit of any one of 1%, 5%, 7.5%, 10%, 15%, 20%, 25%, 30%, 35%, 40%, and 50%, and an upper limit of any one of 30%, 35%, 40%, 45%, 50%, 55%, 60%, 65%, 70%, 75%, 80%, 85%, 90%, 95%, 98%, 99%, 99.9%, 99.99%, and 100%, where any lower limit can be paired with any mathematically compatible upper limit.

The regenerated extraction composition may be fed to one or more extraction units of the extraction zone, such as via one or more flow lines (e.g., line 205A) in fluid communication with the metal atom recovery zone 204 and the extraction zone 202. In some embodiments, the regenerated extraction composition is transported to a storage tank to be used in a subsequent extraction process, for example. In some embodiments, it may be determined via analysis of the extraction composition, recovery efficiency of one or more metal atoms, or both, that the regenerated extraction composition requires additional components (e.g., one or more additional components of the extraction composition). The analysis may be performed with a method or system capable of measuring metal atoms in a solid sample (e.g., an ore material), a liquid sample (e.g., an extracted solution, a regenerated extraction composition), or both. Analysis of one or more embodiments may include determination of total mass loss of the untreated ore material, analysis of a sample (e.g., an extracted solution sample) with absorption spectroscopy, fluorescence spectroscopy, high performance liquid chromatography (HPLC), gas chromatography (GC), mass spectrometry (MS), Infrared Spectroscopy (IR), inductively coupled plasma-optical emission spectrometry (ICP-OES) of a solution, X-ray fluorescence (XRF) of a solid sample, X-ray Diffraction (XRD), Modal Mineralogy analysis (e.g., QEMSCAN® analysis), oxidation-reduction potential (ORP), pH, conductivity or combinations thereof.

A method of one or more embodiments may include providing a measurement system coupled to the extraction system to analyze one or more components of the extraction mixture, such as a regenerated extraction composition. The measurement system may include one or more components configured to perform the analytical methods including, but not limited to ICP-OES, absorption measurement, fluorescence measurements (e.g., excitation and/or emission), HPLC, IR, GC, MS, XRD, XRF, Modal Mineralogy (e.g., QEMSCAN®), ORP, pH, conductivity among others. The measurement system may include various pumps, flow control components, a control system, among other components. The measurement system may be configured to collect a sample and analyze one or more components of the extraction mixture (e.g., a liquid sample of the extraction mixture) over set time intervals and time periods. In some embodiments, the analysis of a solid sample is performed at an off-site location after separation and collection from an extraction mixture.

In some embodiments, analysis of an extracted sample is carried out after each extraction in the extraction zone. Analysis of a regenerated extraction composition may be performed after processing through the metal atom recovery zone. In some embodiments, the extracted sample, the regenerated extraction solution, or both are continuously measured by one or more components of the extraction system. In some embodiments, the extraction system includes one or more sensors capable of collecting and/or transmitting data to a computer that may be a part of the extraction system or at an off-site location. In some embodiments, one or more parameters (e.g., recycled extraction composition make-up, temperature, pressure, residence time within the extraction zone, etc.) is adjusted based on the data collected from the analytical measurements.

In some embodiments, an extraction composition storage tank 206 can be present in system 200 such that one or more components of the extraction composition may be introduced to the regenerated extraction composition via line 207. For example, an extraction composition make-up may be introduced to the regenerated extraction composition to regenerate the concentration of the acid(s) in the extraction composition, to increase the concentration of the extraction composition, or to dilute the extraction composition. In such embodiments, the adjusting of the regenerated extraction composition via introduction of the make-up may maintain or increase the extraction efficiency of target metal component(s), enhance the selectivity of target metal component(s), or both.

In another aspect, embodiments herein relate to a method for improving smelting efficiency of an ore material. The method for improving a smelting efficiency may include one or more steps of a method for extracting one or more impurity components from a copper-containing ore material (e.g., as described in method 100 of FIG. 1). The copper-containing ore material may include a copper concentrate as described previously. The method for improving smelting efficiency may include forming a mixture including an extraction composition and an ore material. The mixture may be as described previously. The method may include selectively removing one or more impurity components as described previously from the ore material with reduced removal of an iron component from the ore material.

While the method may include one or more method steps as described above and as shown in FIG. 1, one of ordinary skill in the art will appreciate that some or all of the blocks may be executed in different orders, may be combined or omitted, and some or all of the blocks may be executed in parallel. Furthermore, the blocks may be performed actively or passively. Alternative methods include the use of these combinations of organic acids and conjugate bases to selectively remove gangue from other copper-containing materials, including, but not limited to, copper carbonates, copper oxides, copper hydroxides, and combinations thereof. The methods according to the present invention can be used in ore processing applications to remove gangue from ore as part of a leach, separate, regenerate circuit.

The method of one or more embodiments may advantageously upgrade a copper ore material (e.g., a copper concentrate) as well as or better than traditional processes. The process of one or more embodiments may be cost-effective and can be adapted to equipment currently used in the mining industry. One or more embodiments of the present disclosure may advantageously improve the smelting efficiency of the ore material after extraction as compared to traditional processes. Additionally, the compositions and methods of one or more embodiments unexpectedly alters the selective removal of a Mg, Al, Mo, Si, and Fe components from a copper ore material in a way that significantly differs operationally from how a more standard solvent (e.g., the inorganic acid, H₂SO₄) solubilizes atoms, salts, and/or minerals from a copper ore material. Further, mixtures of certain concentrations of inorganic and organic acids may allow for reduced cost while retaining the advantage of selectively removing one or more of Al, Mo, Mg, Si, F, and Fe from copper-containing ore material.

One or more embodiments of the present disclosure are advantageous as organic acids and their conjugate bases improve selective solubilization of impurities from ores. In some cases, addition of inorganic acids further improve the removal of gangue material and impurities. Another advantage demonstrated by the present invention is that using the disclosed process for copper-containing ore material reduces the smelting temperature, thereby permitting reduction in the carbon footprint and cost. Furthermore, the one or more embodiments for treating a copper ore material, such as a copper concentrate, has a concentration effect in which selectively solubilizing impurities (e.g., a Mg impurity) can reduce the formation of slag and permit reduction in the carbon footprint and cost. Still another advantage of the present disclosure is that using the disclosed process for a copper ore material, such as a copper concentrate, exposes more copper and allows copper depressants to work more effectively and capture more value from the same amount of material.

### EXAMPLES

The following examples are intended to demonstrate that multiple laboratory experiments were performed to highlight the selectivity for magnesium extraction in accordance with one or more embodiments of the disclosure. These examples are not intended to limit the scope of the present disclosure.

### Example 1

Individual extraction solutions and comparative (i.e., “control”) solutions were prepared according to the amounts shown in Table 1 below as aqueous solutions. Notably, Control-1 was prepared with tap water, and the remaining samples were prepared in Milli-Q water.

TABLE 1
Extraction Solution Composition

| | | Additive |
|---|---|---|
| | | Amount |
| Sample | Extraction Additive | (M) |
| Control-1 | None | 0 |
| Control-2 | Sulfuric Acid | 1.0 |
| Control-3 | Phosphoric Acid | 1.0 |
| Example-1 | Citric Acid | 1.0 |
| Example-2 | Acetic Acid | 1.0 |
| Example-3 | Gluconic Acid | 1.0 |
| Example-4 | Oxalic Acid | 1.0 |
| Example-5 | Malic Acid | 1.0 |
| Control-4 | Sodium Hydroxide | 1.0 |
| | (NaOH) | |

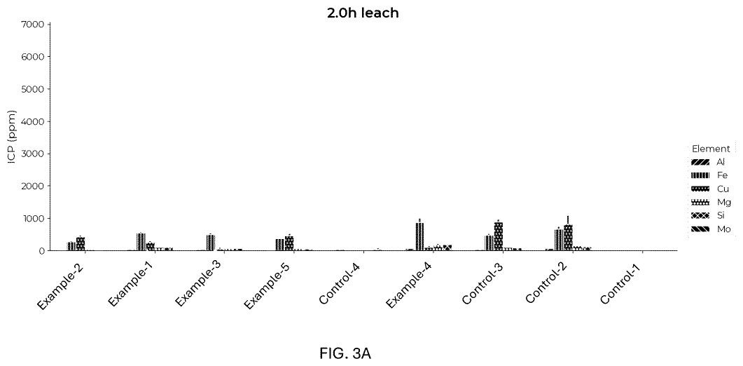

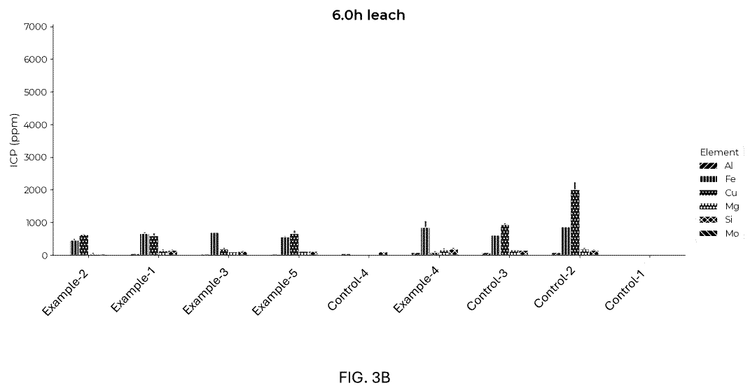

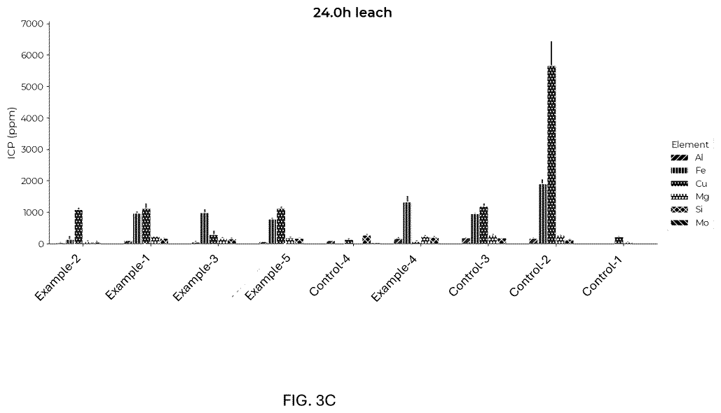

Copper concentrate (10 wt %) was added to each solution. The solutions were then stirred at 60° C. for 24 hours. Liquid samples were taken at 2 h, 6 h, and 24 h and measured on the ICP-OES. Results for these 2 h, 6 h, and 24 h measurements are shown in FIGS. 3A-3C, respectively, which include the aqueous concentrations of key elements in solution. In particular, oxalic and gluconic acid show reduced copper solubilization in solution and as compared to other organic acids and controls.

### Example 2

Individual extraction solutions and comparative (i.e., “control”) solutions were prepared according to the amounts shown in Table 1 above as aqueous solutions. Notably, the Control-1 sample was prepared with tap water, and the remaining samples were prepared in Milli-Q water.

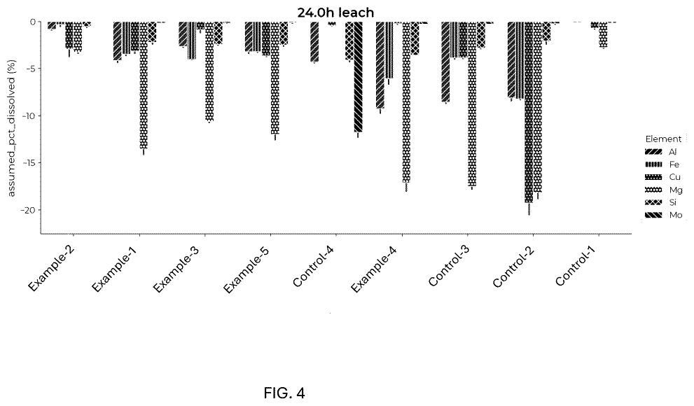

Copper concentrate (10 wt %) was added to each solution. The solutions were then stirred at 60° C. for 24 hours. The percentage of dissolved element was assessed by combining the total mass loss value with XRF and ICP-OES measurements. The combined data for percent dissolved for Al, Cu, Fe, Mg, Mo, and Si are shown in FIG. 4. It was determined that Example-3 and Example-4, which included oxalic acid and gluconic acid, respectively, demonstrated the greatest selectivity for Al, Fe, Mg, Si solubilization while retaining Cu in the solid concentrate material.

### Example 3

Recycling of an extracted solution was evaluated with an ion exchange column using an AmberLite™ IRC120 H Ion Exchange Resin. In particular, an extraction process (or “leaching”) was performed on a copper concentrate (approximately 10 wt %, 51 grams(s) of solid) at 60° C. for 24 hours with gluconic acid (1 M, 400 mL).

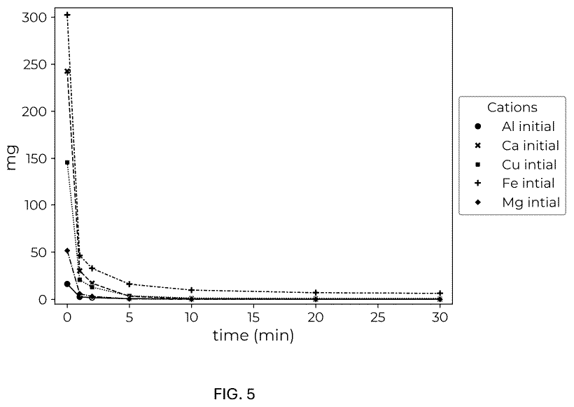

After 24 hours, any remaining solids were separated from the extracted solution. The extracted solution was passed and stirred with the resin (i.e., a resin-in-pulp method) to remove the metal component (i.e., cations of Al, Mg, Fe, Mo) and regenerate the extraction composition. Results are shown in FIG. 5, which shows the absorption of cations to the resin over time. The regenerated extraction composition was then used to treat a fresh copper concentrate (10 wt % solid suspension in water).

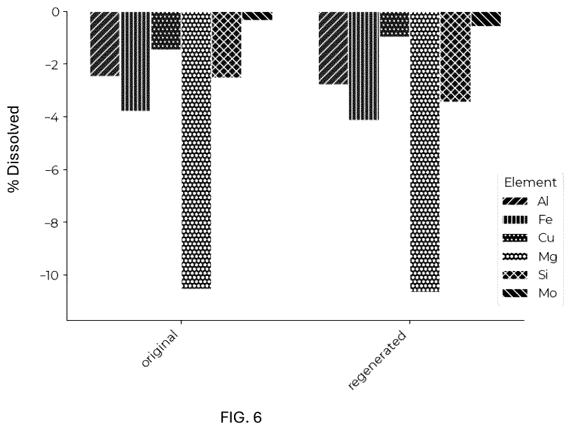

The percentage of dissolved elements in the extracted solution was determined after the first extraction and the second extraction, and results are shown in FIG. 6. For example, the percentage of dissolved element was assessed by combining total volume loss of the liquid extraction composition and ICP-OES measurements of the extracted solution. Data shown in FIG. 6 indicates that there is no loss in selectivity for removal of Mg from the copper concentrate as compared to removal of copper after recycling of the extraction composition.

Throughout the application, ordinal numbers (for example, first, second, third) may be used as an adjective for an element (that is, any noun in the application). The use of ordinal numbers does not imply or create a particular ordering of the elements or limit any element to being only a single element unless expressly disclosed, such as by the use of the terms “before,” “after,” “single,” and other such terminology. Rather, the use of ordinal numbers is to distinguish between the elements. By way of an example, a first element is distinct from a second element, and the first element may encompass more than one element and succeed (or precede) the second element in an ordering of elements.

It is to be understood that the singular forms “a,” “an,” and “the” include plural referents unless the context clearly dictates otherwise. Thus, for example, reference to “a horizontal beam” includes reference to one or more of such beams.

Terms such as “approximately” or “substantially” mean that the recited characteristic, parameter, or value need not be achieved exactly, but that deviations or variations, including, for example, tolerances, measurement error, measurement accuracy limitations, and other factors known to those of skill in the art, may occur in amounts that do not preclude the effect the characteristic was intended to provide.

It is to be understood that one or more of the steps shown in the flowcharts may be omitted, repeated, or performed in a different order than shown. Accordingly, the scope disclosed should not be considered limited to the specific arrangement of steps shown in the flowcharts.

Although multiple dependent claims are not introduced, it would be apparent to one of ordinary skill that the subject matter of the dependent claims of one or more embodiments may be combined with other dependent claims.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A mixture, comprising:
a copper concentrate; and
an extraction composition comprising:
an aqueous solution comprising:
a first organic acid;
an optional additional organic acid; and
optionally an inorganic acid,
wherein the extraction composition is configured to selectively solubilize one or more components comprising a magnesium (Mg) component, an aluminum (Al) component, a silicon (Si) component, a fluorine (F) component, an iron (Fe) component, a molybdenum (Mo) component, or any combination thereof from the copper concentrate,
wherein the one or more components comprise one or more of an atom, a mineral, a salt of Mg, Al, Si, F, Fe, Mo, or any combination thereof.

2. The mixture of claim 1, wherein:
when the first organic acid is gluconic acid, the additional organic acid comprises an acid selected from the group consisting of citric acid, oxalic acid, formic acid, lactic acid, acetic acid, malic acid, hydroxypropionic acid, phthalic acid, tartaric acid, hexadecenoic acid, heptadecanoic acid, gallic acid, aspartic acid, succinic acid, oleic acid, tannic acid, palmitic acid, and combinations thereof; or
when the first organic acid is oxalic acid, the additional organic acid comprises an acid selected from the group consisting of gluconic acid, malic acid, formic acid, lactic acid, acetic acid, citric acid, hydroxypropionic acid, phthalic acid, tartaric acid, hexadecenoic acid, heptadecanoic acid, gallic acid, aspartic acid, succinic acid, oleic acid, tannic acid, palmitic acid, and combinations thereof.

3. The mixture of claim 1, wherein an extracted Mg component, Al component, Si component, F component, Fe component, Mo component, Cu component or any combination thereof has a purity in a range from 1% to 80%.

4. The mixture of claim 1, wherein the copper concentrate comprises a copper-containing compound selected from the group consisting of copper sulfides, copper carbonates, copper hydroxides, copper oxides, and combinations thereof.

5. The mixture of claim 1, wherein the inorganic acid comprises an acid selected from the group consisting of sulfuric acid, hydrochloric acid, nitric acid, phosphoric acid, and combinations thereof.

6. The mixture of claim 1, comprising the inorganic acid in an amount in a range from 0 to 1M, and wherein a pH of the extraction composition is in a range from 0.1 to 4.

7. The mixture of claim 1, wherein the aqueous solution is a biobroth obtained from a natural and/or engineered organic acid-producing microbe, a natural and/or engineered organic acid-producing plant, or combinations thereof.

8. The mixture of claim 1, wherein a concentration ratio of the first organic acid to the additional acid is in a range from 1:0 to 1: ≤1.

9. A method for improving a smelting efficiency of a copper concentrate, the method comprising:
forming the mixture of claim 1; and
separating a treated copper concentrate from the mixture of claim 1, wherein the treated copper concentrate comprises:
a reduced Mg component, Al component, Fe component, Si component, F component, and/or Mo component content of 10 to 90 relative % less than the copper concentrate.

10. A method for extracting a metal from copper concentrate, the method comprising:
selectively solubilizing a Mg component, Al component, Fe component, Si component, F component, and/or Mo component comprising one or more minerals, one or more salts, or any combination thereof from copper concentrate into an extraction composition,
wherein the extraction composition comprises an aqueous solution of an organic acid, an optional additional organic acid, and an optional inorganic acid.

11. The method of claim 9, further comprising:
separating a treated copper concentrate thereof from a mixture comprising the extraction composition and the Mg component, the Al component, the Fe component, the Si component, the F component, and/or the Mo component.

12. The method of claim 10, wherein selectively solubilizing comprises:
introducing the extraction composition to an extraction zone;
introducing the copper concentrate to the extraction zone, thereby forming a mixture with the extraction composition;
agitating the extraction mixture in the extraction zone to form a liquid mixture comprising the organic acid, the one or more components, and, optionally, one or more additional components extracted from the copper concentrate; and
separating the liquid mixture from the copper concentrate.

13. The method of claim 12, further comprising:
separating the one or more components from the liquid mixture; and
recovering the extraction composition to produce a recovered extraction composition,
wherein the separated one or more components has a purity in a range from 10% to 100%.

14. The method of claim 13, further comprising:
introducing the recovered extraction composition from the liquid mixture to the extraction zone, thereby recycling the extraction composition.

15. The method of claim 13, wherein separating the one or more components from the liquid mixture comprises extracting the one or more components from the liquid mixture with one or more water treatment techniques.

16. The method of claim 15, wherein extracting the Mg component, the Fe component, the Al component, the Mo component, a Cu component, the F component, the Si component, the extraction components, or combinations thereof comprises performing one or more water treatment techniques selected from the group consisting of feeding the liquid mixture through an ion exchange system, using solvent extraction, chromatography, filtration, membrane filtration, osmotic separation, using adsorption and/or absorption materials, using pH control and precipitation, or combinations thereof.

17. The method of claim 12, further comprising:
adjusting a temperature of the extraction zone to a temperature in a range from 20 to 100° C.;
wherein the mixture is in the extraction zone for a period of time in a range from 1 to 24 hours.

18. A method for extracting an impurity from a copper concentrate, the method comprising:
extracting one or more components with an extraction composition, wherein the one or more components comprises:
one or more of a Mg component, Al component, Fe component, Si component, F component, and/or Mo component, and
one or more minerals, one or more salts, or any combination thereof from the copper concentrate,
wherein the extraction composition comprises an aqueous solution of an organic acid selected from gluconic acid, oxalic acid, and mixtures thereof;
separating the copper concentrate from the one or more components and the extraction composition;
separating the extraction composition from the one or more components; and
repeating the extracting,
wherein the separated one or more components have a purity in a range from 10% to 90%.

19. The method of claim 18, wherein the separated copper concentrate thereof comprises:
a reduced Mg component, Al component, Fe component, Si component, F component, and/or Mo component content of 10 to 90 wt % less than the copper concentrate.

20. The method of claim 18, wherein the separated copper concentrate has a penalty component reduction relative to an untreated copper concentrate, wherein the penalty component reduction is in a range from 1% to 100%.
